(19) United States
(12) Patent Application Publication
(10) Pub. No.: US 2016/0134397 A1
(43) Pub. Date: May 12, 2016

(54) BASE STATION AND CONTROL METHOD

(71) Applicant: FUJITSU LIMITED, Kawasaki-shi (JP)

(72) Inventor: Takaharu KOBAYASHI, Yamato (JP)

(21) Appl. No.: 14/930,414

(22) Filed: Nov. 2, 2015

(30) Foreign Application Priority Data
Nov. 11, 2014 (JP) 2014-229337

(51) Int. Cl. H04L 5/00; H04W 24/10; H04W 48/20

(52) U.S. Cl. CPC H04L 5/0035; H04W 48/20; H04W 24/10

(57) ABSTRACT

A base station including: a processor configured to perform coordinated reception of a signal transmitted from a specified wireless terminal under control of the base station, with at least one coordinated base station, a memory configured to store each of a plurality of pieces of first information relating to each amount of each interference caused to a desired signal by each interference signal, the desired signal being transmitted from the specified wireless terminal, each interference signal being transmitted from each wireless terminal under control of each of a plurality of other base stations, and the processor configured to select the at least one coordinated base station from among the plurality of other base stations based on the plurality of pieces of the first information.

### CROSS-REFERENCE TO RELATED APPLICATION

This application is based upon and claims the benefit of priority of the prior Japanese Patent Application No. 2014-229337, filed on Nov. 11, 2014, the entire contents of which are incorporated herein by reference.

### FIELD

The embodiments discussed herein are related to, for example, a base station and a control method for selecting a coordinated base station.

### BACKGROUND

As one of uplink coordinated multi-point (CoMP) transmission/reception schemes, a scheme called multi-user joint reception (MU-JR) or multi-cell interference rejection combining (IRC) has been considered.

The MU-JR is a technology by which characteristics (throughputs) are improved by sharing received data between base stations and performing reception of the data so that antennas of the plurality of base stations and antennas of a plurality of wireless terminals are regarded as a large-scale multiple input multiple output (MIMO).

FIG. 1 is a diagram illustrating the MU-JR. As illustrated in FIG. 1, it is assumed that there are base stations 1A and 2A that respectively forms two adjacent cells 1 and 2. A wireless terminal (also referred to as “user equipment (UE)”) 3 is coupled to the base station 1A, and UE 4 is coupled to the base station 2A. In such a situation, it is assumed that the UE 3 is a CoMP target, and the MU-JR is performed for the UE 3. In this case, the cell 1 of the base station 1A to which the UE 3 is coupled is “local cell”, and the cell 2 is a coordinated cell (further cell) that performs coordinated reception. The UE 3 performs transmission of a signal destined for the cell 1 and a signal destined for the cell 2. The base station 2A (cell 2) transmits signals that have been received from the UE 3 and the UE 4 to the base station 1A through a link 5. The base station 1A executes equalization processing so as to perform equalization weight calculation, and executes reception processing of a signal from the UE 3.

Japanese National Publication of International Patent Application No. 2014-511086, and Japanese National Publication of International Patent Application No. 2013-509082 are related arts.

### SUMMARY

According to an aspect of the invention, a base station includes a processor configured to perform coordinated reception of a signal transmitted from a specified wireless terminal under control of the base station, with at least one coordinated base station, a memory configured to store each of a plurality of pieces of first information relating to each amount of each interference caused to a desired signal by each interference signal, the desired signal being transmitted from the specified wireless terminal, each interference signal being transmitted from each wireless terminal under control of each of a plurality of other base stations, and the processor configured to select the at least one coordinated base station from among the plurality of other base stations based on the plurality of pieces of the first information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating coordinated multi-point reception (MU-JR);

FIG. 2 is a diagram illustrating a reference example;

FIG. 3 is a diagram illustrating a first embodiment;

FIG. 4 is a diagram illustrating a configuration example of a network system according to a second embodiment;

FIG. 5 is a diagram illustrating a hardware configuration example of a base station applied as each base station illustrated in FIG. 4;

FIG. 6 is a diagram schematically illustrating a configuration example of a base station;

FIG. 7 is a diagram illustrating an example of weight calculation;

FIG. 8 is a sequence diagram illustrating an operation example in the second embodiment;

FIG. 9 is a diagram illustrating an example of a scheduling result of a wireless resource of uplink in each base station; and

FIG. 10 is a sequence diagram illustrating a modification of the second embodiment.

### DESCRIPTION OF EMBODIMENTS

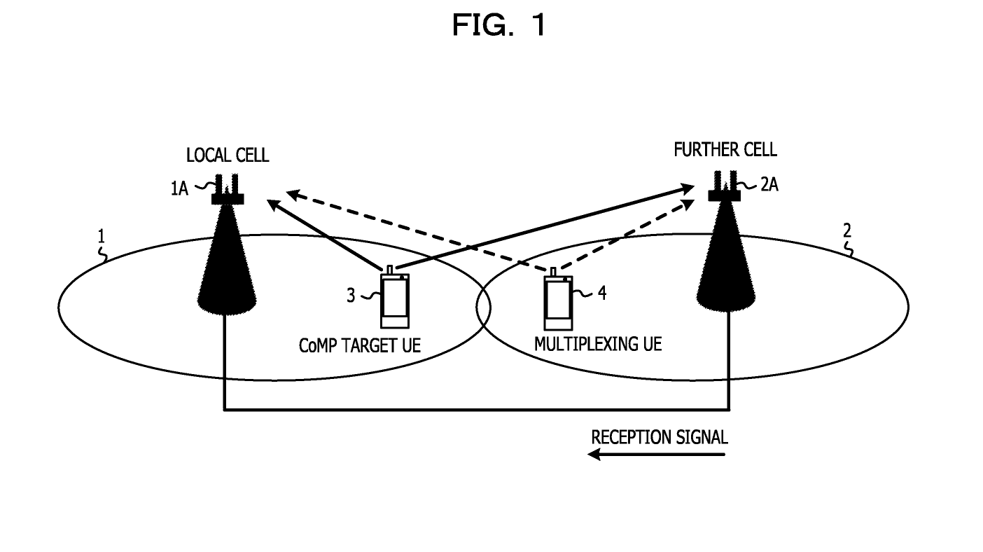

In FIG. 1, the example is described in which a single coordinated cell (further cell) is provided, but in the MU-JR, an increase in the number of coordinated cells causes the characteristics to be improved. However, with the increase in the number of coordinated cells, a received data amount and a processing amount in the base station of the local cell are also increased, and the load in the base station of the local cell is increased, so that it is desirable that the number of coordinated cells is included within a certain range.

As a selection method of a further cell (coordinated cell) that obtains a reception signal from UE, there is a method in which a cell in which a difference between a downlink reception signal from the local cell and a downlink reception signal from a further cell in UE that is a CoMP target is small is selected as a coordinated cell. When it is assumed that transmission power of the base stations is fixed, the method is equal to selection of a cell having large uplink reception power from among adjacent cells. For example, a first adjacent cell having large reception power is selected as a coordinated cell from among the first adjacent cell and a second adjacent cell that are adjacent to the local cell.

However, in the above-described method, an increase amount of a desired signal is merely considered. The selected adjacent cell may not achieve excellent characteristics (throughputs). For example, in the above-described example, when the first adjacent cell is selected as the coordinated cell, interference from the first adjacent cell is removed by coordinated reception processing. On the contrary, interference from the second adjacent cell that has not been selected as the coordinated cell is not removed. Here, when the interference amount from the second adjacent cell is large, an influence of the interference residual from the second adjacent cell is larger than the influence of the increase effect of the desired signal due to selection of the first adjacent cell, so that it is probable that the characteristics (throughputs) are reduced as compared with a case in which the second adjacent cell is selected.

An object of an embodiment is to provide a technology capable of improving a quality of a signal received using coordinated reception.

Embodiments are described with reference to drawings. Configurations of the embodiments are merely examples, and the embodiments are not limited to such examples.

<Reference Example>

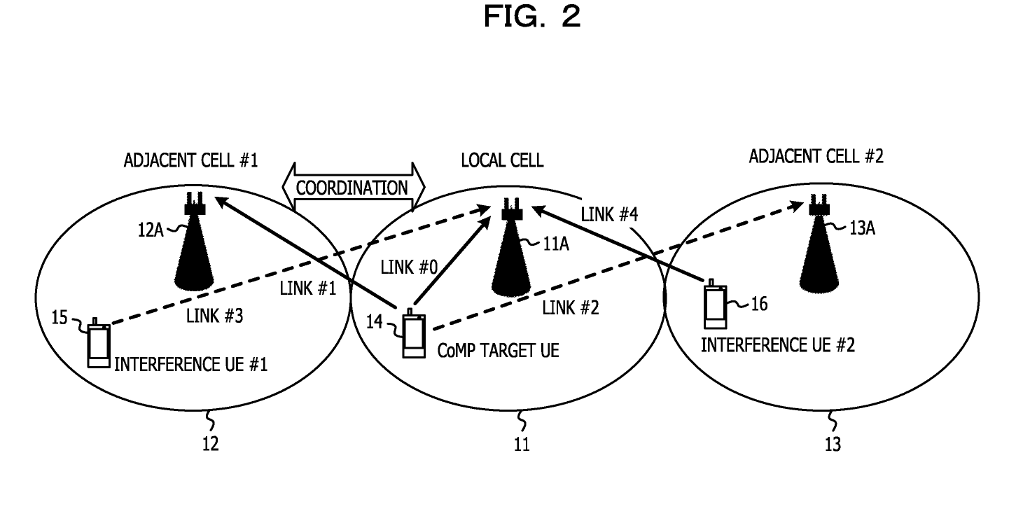

A reference example is described first. FIG. 2 is a diagram illustrating a reference example. In FIG. 2, a base station 11A that forms a cell 11, a base station 12A that forms a cell 12 that is an adjacent cell of the cell 11, and a base station 13A that forms a cell 13 that is an adjacent cell of the cell 11 are illustrated.

UE 14 is coupled to the base station 11A, and UE 15 is coupled to the base station 12A, and UE 16 is coupled to the base station 13A. When the UE 14 is a CoMP target, the cell 11 is the local cell, and the cell 12 is an adjacent cell #1, and the cell 13 is an adjacent cell #2.

When the base station 11A sets the number of coordinated cells at 2, and performs coordinated reception (MU-JR) for the UE 14, the base station 11A determines a coordinated cell from among the adjacent cell #1 (cell 12) and the adjacent cell #2 (cell 13), as described below. The base station 11A receives a reception signal of the adjacent cell #1, that is, a signal (link #1) that the base station 12A receives from the UE 14, and a reception signal of the adjacent cell #2, that is, a signal (link #2) that the base station 13A receives from the UE 14.

The base station 11A compares the reception signal of the adjacent cell #1 with the reception signal of the adjacent cell #2, and determines the base station (adjacent cell) that is the transmission source of the reception signal having the largest digital signal, as the coordinated cell. In the example of FIG. 2, the adjacent cell #1 (base station 12A) is selected as the coordinated cell.

In addition, coordinated reception is performed between the base station 11A and the base station 12A for signals transmitted from the UE 14 using links #0 and #1. At this time, the UE 15 is an interference UE #1 that performs transmission of an interference signal (link #3) for the transmission signal from the UE 14, and the UE 16 is an interference UE #2 that performs transmission of an interference signal (link #4) for the transmission signal from the UE 14.

At this time, the interference from the UE 15 (interference UE #1) is removed by the coordinated processing in the base station 11A. On the contrary, the interference from the UE 16 (interference UE #2) is not removed. Thus, when the interference from the link #4 is larger than the interference from the link #2, the influence of the interference residual from the link #4 becomes larger than the influence of the increase effect of the desired signal due to the selection of the link #1, so that the characteristics of the coordinated reception may not be improved.

In the following embodiment, a selection method of a coordinated base station (coordinated cell) is described, by which the quality of a signal received using coordinated reception is improved, and the characteristics of the coordinated reception (throughputs of uplink transmission) are improved.

### First Embodiment

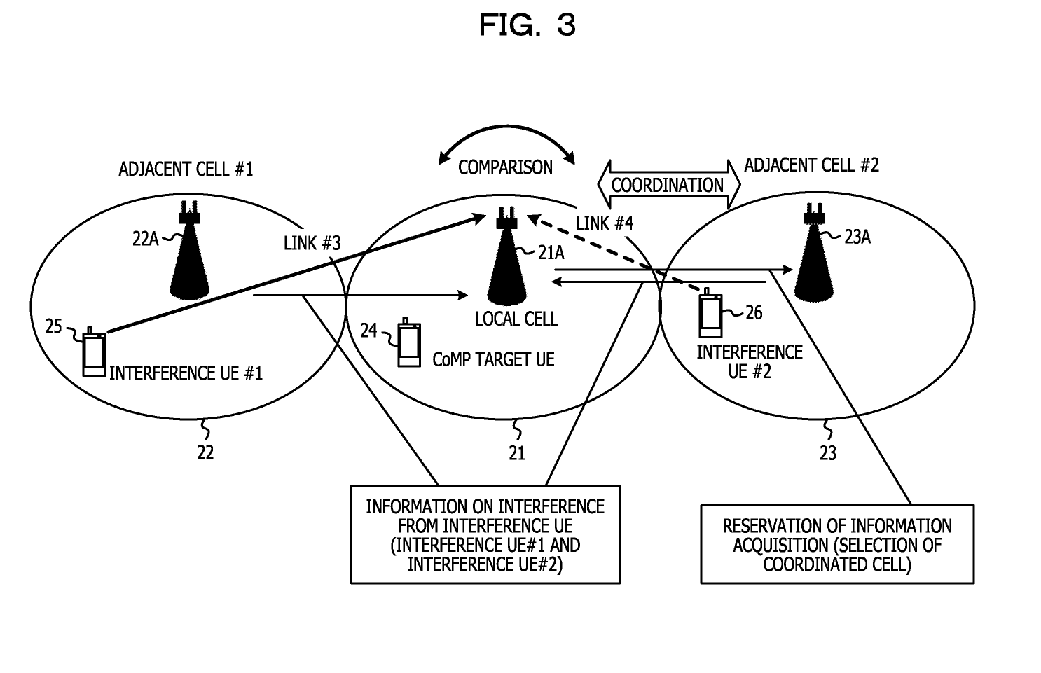

FIG. 3 is a diagram illustrating a first embodiment. A network system according to the first embodiment includes a base station device that forms a cell (hereinafter simply referred to as “base station”) and a plurality of adjacent base stations that respectively form adjacent cells of the cell. In the example illustrated in FIG. 3, a base station 21A that forms a cell 21, a base station 22A that forms a cell 22 that is an adjacent cell (adjacent cell #1) of the cell 21, and a base station 23A that forms a cell 23 that is an adjacent cell (adjacent cell #2) of the cell 21 are illustrated.

UE 24 is coupled to the base station 21A. UE 25 is coupled to the base station 22A. UE 26 is coupled to the base station 23A. When the UE 24 is set as a CoMP target UE, and coordinated reception (MU-JR) is performed for the UE 24, the base station 21A selects an adjacent base station that becomes a coordinated base station. The number of selected base stations (the certain number of coordinated base stations) may be set as appropriate. In the example illustrated in FIG. 3, the number of selected base stations is 1, and the number of base stations between which coordinated reception is performed is 2.

The base station 21A is an example of “base station”, and the base station 22A and the base station 23A are examples of “plurality of adjacent base stations” or “plurality of other base stations”. The UE 24 is an example of “specified wireless terminal under the control of the base station”. As a result of scheduling of a wireless resource, each of the UE 25 and 26 uses the same wireless resource as the wireless resource that has been allocated to the UE 24. As a result, each of the UE 25 and 26 performs transmission of a signal that interferes with the signal from the UE 24 at the time of transmission of the signal by the UE 24. That is, the UE 25 and 26 respectively operate as interference UE #1 and #2. The UE 25 and 26 are examples of “each wireless terminal under control of each of a plurality of other base stations” respectively.

The base station 21A obtains pieces of information on interference from the UE 25 (interference UE #1) and interference from the UE 26 (interference UE #2), from the base stations 22A and 23A that are the adjacent base stations (adjacent cells). The information on the interference may include a result of scheduling of the wireless resource.

The base station 21A stores the pieces of information on the interference, which have been obtained from the base stations 22A and 23A, and calculates an interference amount corresponding to each of the adjacent base stations using the information on the interference. The base station 21A selects an adjacent base station that becomes a coordinated base station, in order of the size of an interference amount, largest first. In the example illustrated in FIG. 3, the interference amount corresponding to the base station 23A is larger than the interference amount corresponding to the base station 22A. Therefore, the base station 21A selects the base station 23A as the coordinated base station (coordinated cell). In the example of FIG. 3, the number of selected base stations is 1, so that selection of a coordinated base station is completed.

In the first embodiment, when the base station 23A the interference amount of which is larger than that of the base station 22A is selected as the coordinated base station, the interference from the UE 26 may be removed by the coordinated reception processing, and the quality of a signal received using coordinated reception may be improved. Due to the improvement of the quality, an error rate or the like is reduced, so that the characteristics of the coordinated reception (throughputs of uplink transmission) may also be improved.

### Second Embodiment

The selection method of the coordinated base station in the first embodiment is described in detail as a second embodiment.

<System Configuration>

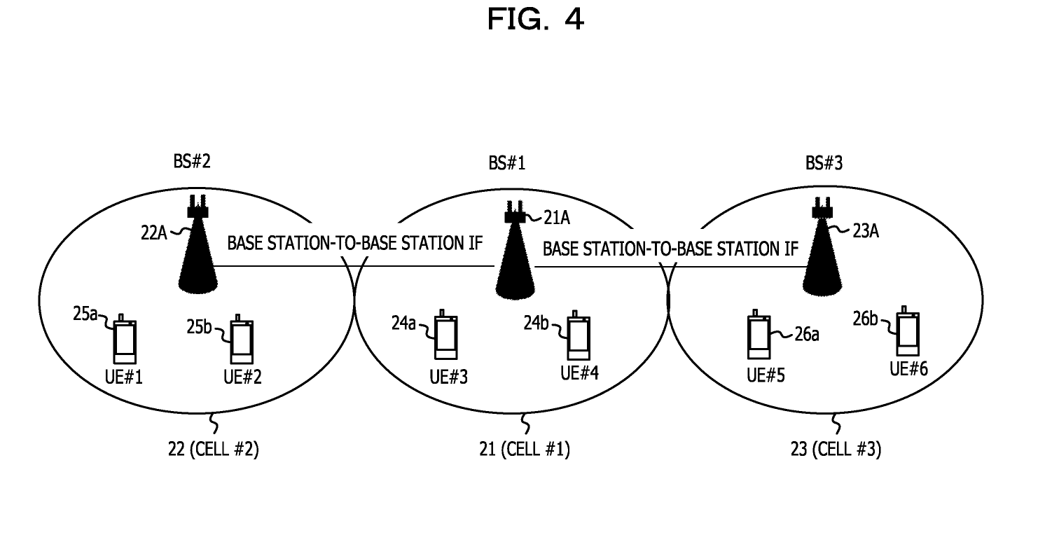

FIG. 4 is a diagram illustrating a configuration example of a network system according to the second embodiment. The network system includes a plurality of base stations. The base station configuration illustrated in FIG. 4 is similar to FIG. 3. That is, as the plurality of base stations, the base station 21A (hereinafter referred to as “BS #2”), the base station 22A (hereinafter referred to as “BS #1”), and the base station 23A (hereinafter referred to as “BS #3”) are included in the network system. The BS #1, #2, and #3 are coupled to each other through interfaces through which signals are allowed to be exchanged (base station-to-base station IFs).

The BS #1, #2, and #3 respectively form the cell 21 (cell #1), the cell 22 (cell #2), and the cell 23 (cell #3) by radio wave emission to the UE. When viewed from the BS #2, the cell #2 formed by the BS #2 is the local cell, and the cell #1 and the cell #3 that are respectively formed by the BS #1 and the BS #3 are adjacent cells (further cells) of the cell of the BS #2.

UE 25a (hereinafter referred to as “UE #1”) and UE 25b (hereinafter referred to as “UE #2”) are coupled to the BS #1. UE 24a (hereinafter referred to as “UE#3”) and UE 24b (hereinafter referred to as “UE #4”) are coupled to the BS #2. UE 26a (hereinafter referred to as “UE #5”) and UE 26b (hereinafter referred to as “UE #6”) are coupled to the BS #3.

<Configuration of the Base Station>

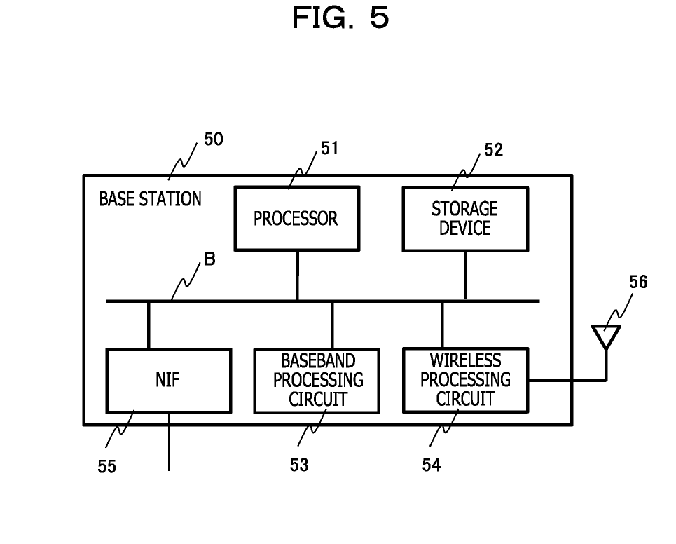

FIG. 5 illustrates a hardware configuration example of a base station allowed to be applied to each of the base stations (the BS #1, #2, and #3) illustrated in FIG. 4. In FIG. 5, a base station 50 includes, for example, a processor 51, a storage device 52, a baseband processing circuit 53, a wireless processing circuit 54, and a network interface (NIF) 55 that are coupled to each other through a bus B. An antenna 56 is coupled to the wireless processing circuit 54.

The NIF 55 is an interface circuit that accommodates a line that connects an adjacent base station and a base station, and a line that connects a base station and a host device (core network device). The NIF 55 is formed, for example, using a local area network (LAN) card or a network interface card (NIC). The line may be a metal cable or an optical fiber. When the optical fiber is applied, the NIF 55 includes an optical-electrical conversion device (E/O or O/E). In addition, as a base station-to-base station IF formed by the NIF 55, a common public radio interface (CPRI) may be applied.

The storage device 52 stores various programs executed by the processor 51 and data used at the time of execution of the programs. The storage device 52 includes a main memory used as a work area of the processor 51 and an auxiliary memory mainly used as a storage area of the programs and the data.

The main memory is obtained, for example, by a random access memory (RAM) and a read only memory (ROM). The auxiliary memory is obtained, for example, by selecting at least one of a hardware disk drive (HDD), a flash memory, an electrically erasable programmable read-only memory (EEPROM), a solid state drive (SSD), and the like. The storage device 52 is an example of “memory”, “computer-readable storage medium”, or the like.

The baseband processing circuit 53 executes digital baseband processing. For example, the baseband processing circuit 53 generates a baseband signal by performing data coding and digital modulation, and supplies the baseband signal to the wireless processing circuit 54. In addition, the baseband processing circuit 53 executes demodulation processing, decoding processing, and the like of the baseband signal supplied from the wireless processing circuit 54.

The wireless processing circuit 54 converts the baseband signal supplied from the baseband processing circuit 53, into an analog signal, up-converts the analog signal to a signal having a wireless frequency (RF), amplifies the up-converted signal, and emits the signal through the antenna 56. In addition, the wireless processing circuit 54 amplifies a signal that has been received through the antenna 56 with low noise, down-converts the signal to obtain an analog signal, and converts the analog signal into a baseband signal by analog-digital conversion. The baseband signal is supplied to the baseband processing circuit 53.

The processor 51 is obtained by a dedicated or general-purpose processor. The processor 51 may be obtained, for example, by at least one of a central processing unit (CPU), a micro processing unit (MPU), and a digital signal processor (DSP). The processor 51 is an example of “control device” or “controller”. The processor 51 executes various pieces of processing by executing the stored programs. For example, the processor 51 controls operations of the baseband processing circuit and the wireless processing circuit. In addition, the processor 51 executes call processing of UE, maintenance and monitoring processing of a base station, and the like.

Each of the baseband processing circuit 53 and the wireless processing circuit 54 is formed, for example, by a combination of an electrical and electronic circuit and an integrated circuit (at least one of an IC, a LSI, and an application specific integrated circuit (ASIC) is selected). The integrated circuit may include a programmable logic device (PLD) such as a field programmable gate array (FPGA). In addition, a part or all of pieces of processing executed by the processor may be executed by hardware logic (wired logic) using the above-described circuit.

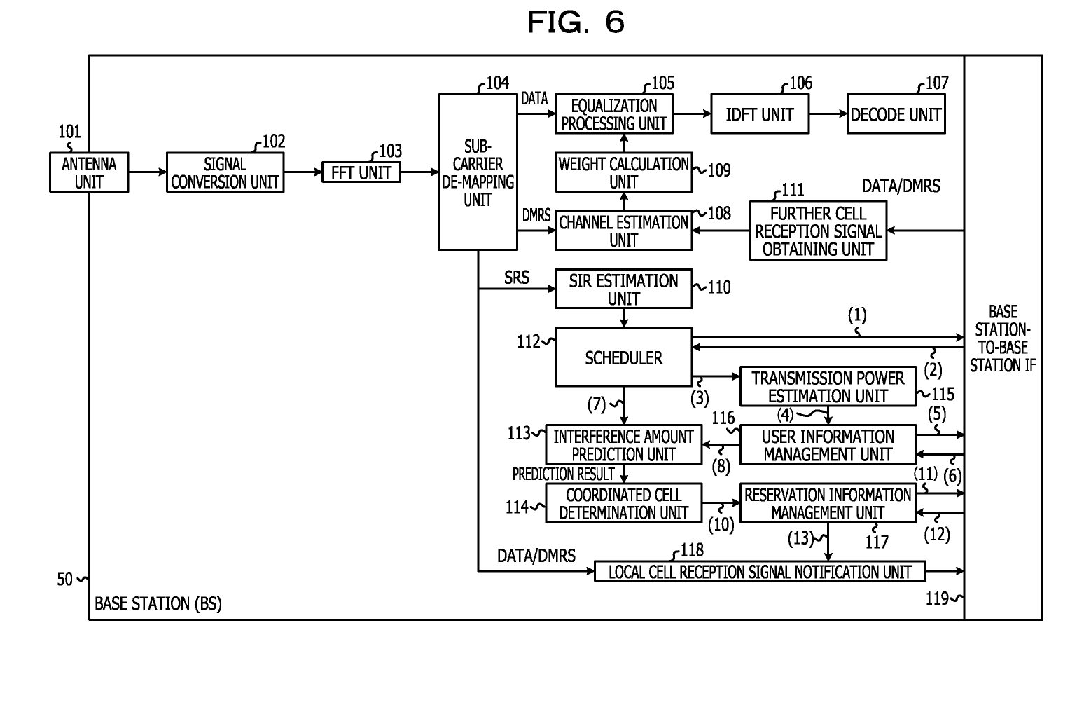

FIG. 6 is a diagram schematically illustrating a configuration example of the base station 50. In FIG. 6, the base station 50 operates as a device including the following operation blocks. The base station 50 includes an antenna unit 101, a signal conversion unit 102, an FFT unit 103, a sub-carrier de-mapping unit 104, an equalization processing unit 105, an IDFT unit 106, and a decode unit 107. In addition, the base station 50 further includes a channel estimation unit 108, a weight calculation unit 109, and an SIR estimation unit 110.

In addition, the base station 50 further includes a further cell reception signal obtaining unit 111, a scheduler 112, an interference amount prediction unit 113, a coordinated cell determination unit 114, and a transmission power estimation unit 115. In addition, the base station 50 further includes a user information management unit 116, a reservation information management unit 117, a local cell reception signal notification unit 118, and a base station-to-base station IF 119.

The antenna 56 illustrated in FIG. 5 operates as the antenna unit 101. The wireless processing circuit 54 operates as the signal conversion unit 102. The baseband processing circuit 53 operates as a device including the FFT unit 103, the sub-carrier de-mapping unit 104, the equalization processing unit 105, the IDFT unit 106, and the decode unit 107. In addition, the baseband processing circuit 53 operates as a device including the channel estimation unit 108, the weight calculation unit 109, and the SIR estimation unit 110.

The processor 51 operates as the obtaining unit 111, the scheduler 112, the estimation unit 115, the interference amount prediction unit 113, and the coordinated cell determination unit 114 by executing the programs stored in the storage device 52. In addition, the processor 51 operates the user information management unit 116, the reservation information management unit 117, and the notification unit 118 by executing the programs. The storage device 52 stores user information managed by the user information management unit 116 and reservation information managed by the reservation information management unit 117. In addition, the NIF 55 operates as the base station-to-base station IF 119.

The antenna unit 101 performs transmission and reception of a wireless signal. The signal conversion unit 102 converts the wireless signal into a baseband signal, and supplies the signal to the FFT unit 103. The FFT unit 103 removes cyclic prefix (CP) from the received signal that is the baseband signal, and performs fast fourier transform (FFT).

The sub-carrier de-mapping unit 104 extracts a sub-carrier to which each UE is allocated, from the signal that has been subjected to FFT. The output of the sub-carrier de-mapping unit 104 is changed depending on the content of a symbol (sub-carrier). The output may include data of a physical uplink shared channel (PUSCH), a demodulation reference signal (DMRS), and a sounding reference signal (SRS). The DMRS is a reference signal used for channel estimation for data demodulation (demodulation reference signal), and the SRS is a reference signal used for channel quality measurement.

The channel estimation unit 108 estimates a channel between the local base station and UE (UE of the local base station and UE of the further base station). The weight calculation unit 109 calculates reception weight using the channel estimation value obtained from the channel estimation unit.

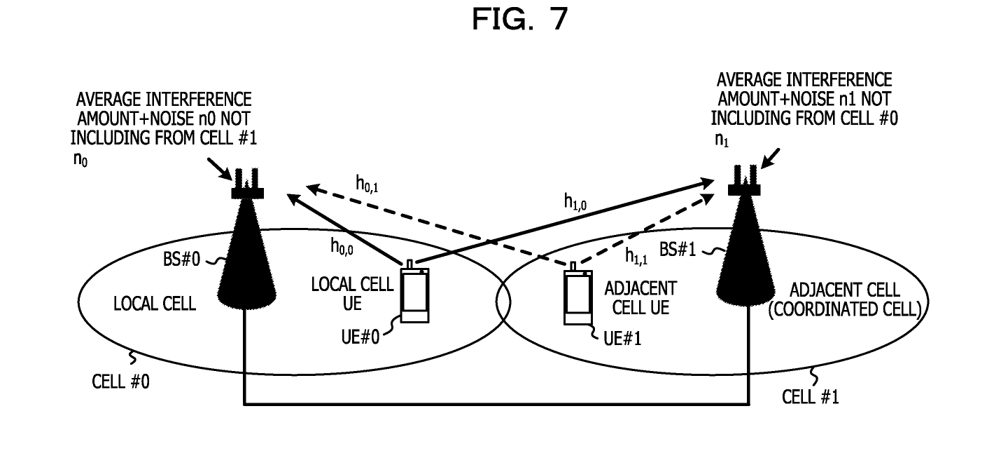

FIG. 7 is a diagram illustrating an example of weight calculation performed in the weight calculation unit 109. In the example of FIG. 7, the number of cells between which coordinated reception is performed is 2, and coordinated reception is performed between a cell #0 (local cell: BS #0) and a cell #1 (BS #1) that is an adjacent cell of the cell #0. The number of coordinated cells (adjacent cells) is 1. UE #0 is coupled to the BS #0, and the UE #1 is coupled to the BS #1, and UE #0 is a CoMP (MU-JR) target.

Weight w_{c}(k)^{H} is calculated using the following formula (1). A variable H_{c}(k) in the formula (1) is a channel estimation value, and is represented by the following formula (2). In addition, a variable N_{c} in the formula (1) indicates an interference amount and noise.

$$\begin{matrix}{{w}_{c} ( k )}^{H} = {{h}_{c , 0} ( k )}^{H} {( {H}_{c} ( k ) {{H}_{c} ( k )}^{H} + {N}_{c} )}^{- 1} & ( 1 ) \\ {H}_{c} ( k ) = [ \begin{matrix}{h}_{c , 0} ( k ) & {h}_{c , 1} ( k )\end{matrix} ] = [ \begin{matrix}{h}_{0 , 0} ( k ) & {h}_{0 , 1} ( k ) \\ {h}_{1 , 0} ( k ) & {h}_{1 , 1} ( k )\end{matrix} ] & ( 2 ) \\ {N}_{c} = [ \begin{matrix}{n}_{0} I & 0 \\ 0 & {n}_{1} I\end{matrix} ] & ( 3 )\end{matrix}$$

The element h_{0,0} of a matrix in the formula (2) indicates a channel estimation value in the local cell of UE allocated to the local cell. That is, the element h_{0,0} indicates a channel estimation value of a signal that the BS #0 receives from the UE #0. The element h_{0,1} indicates a channel estimation value in the local cell of UE allocated to the adjacent cell. That is, the element h_{0,1} indicates a channel estimation value of a signal that the BS #0 receives from the UE #1. The element h_{1,0} indicates a channel estimation value in the adjacent cell of the UE allocated to the local cell. That is, the element h_{1,0} indicates a channel estimation value of a signal that the BS #1 receives from the UE #0. In addition, the element h_{1,1} indicates a channel estimation value in the adjacent cell of the UE allocated to the adjacent cell. That is, the element h_{1,1} indicates a channel estimation value of a signal that the BS #1 receives from the UE #1.

In addition, “k” in the formula (1) and the formula (2) indicates a sub-carrier number. In addition, “n₀” in the formula (3) indicates an average interference amount and noise not including from the cell #1, and “n₁” indicates an average interference amount and noise not including from the cell #0.

The equalization processing unit executes equalization processing using a reception signal of the local base station, a reception signal of the further base station, and the weight that has been calculated by the weight calculator. The IDFT unit 106 performs inverse discrete fourier transform (IDFT) on the signal that has been subjected to the equalization processing. The decode unit (decoder) 107 decodes the output signal from the IDFT unit 106 to obtain desired data.

The further cell reception signal obtaining unit 111 obtains a reception signal (including data and a DMRS) indicating timing at which obtaining reservation has been performed and the resource on which the obtaining reservation has been performed, from the further cell through the base station-to-base station IF 119. The SIR estimation unit 110 calculates a signal to interference power ratio (SIR) used for scheduling using an SRS that has been output form the sub-carrier de-mapping unit 104.

The scheduler 112 performs uplink resource scheduling, based on the SIR that has been calculated by the SIR estimation unit 110. The scheduler 112 operates as a scheduling information notification unit that notifies the further cell of the scheduling result of the local cell ((1) of FIG. 6) through the base station-to-base station IF 119. In addition, the scheduler 112 also operates as a scheduling information obtaining unit that obtains the scheduling result from the further cell ((2) of FIG. 6) through the base station-to-base station IF unit 119.

The scheduler 112 transmits reference signal received power (RSRP) information ((3) of FIG. 6) to the transmission power estimation unit 115. The transmission power estimation unit 115 calculates an estimation value of transmission power using the RSRP information. The estimation value of the transmission power (transmission power information: (4) of FIG. 6) is transmitted to the user information management unit 116.

The user information management unit 116 operates as a UE information obtaining unit that obtains further cell information ((5) of FIG. 6) including transmission power information and RSRP of the further cell, through the base station-to-base station IF 119, and stores the further cell information in the storage device 52. The RSRP is reception power of a reference signal per one resource element (band 15 kHz). In addition, the user information management unit 116 transmits the local cell information ((6) of FIG. 6) including the transmission power information and the RSRP of the local cell stored in the storage device 52, to the further cell through the base station-to-base station IF 119.

The interference amount prediction unit 113 predicts an interference amount from the scheduling results of the local cell and the further cell ((7) of FIG. 6), and the RSRP and the transmission power information ((8) of FIG. 6) supplied from the user information management unit 116. The coordinated cell determination unit 114 determines a coordinated cell from the prediction result of the interference amount ((9) of FIG. 6). The selection result of the coordinated cell ((10) of FIG. 6) is transmitted to the reservation information management unit 117.

The reservation information management unit 117 operates as a reservation information notification unit that notifies the further cell of obtaining reservation of the reception signal ((11) of FIG. 6) through the base station-to-base station IF 119. In addition, the reservation information management unit 117 operates as a reservation information obtaining unit that accepts obtaining reservation information of the reception signal ((12) of FIG. 6) from the further cell.

The local cell reception signal notification unit 118 receives an output from the sub-carrier de-mapping unit 104 (reception signal from the UE including data and a DMRS). The notification unit 118 selects information that is to be transmitted to the further cell, in accordance with the obtaining reservation information from the further cell (including information on a resource of a transfer target and transfer destination: (13) of FIG. 6), and transmits the information to the further cell through the base station-to-base station IF unit.

<Operation Example of the System>

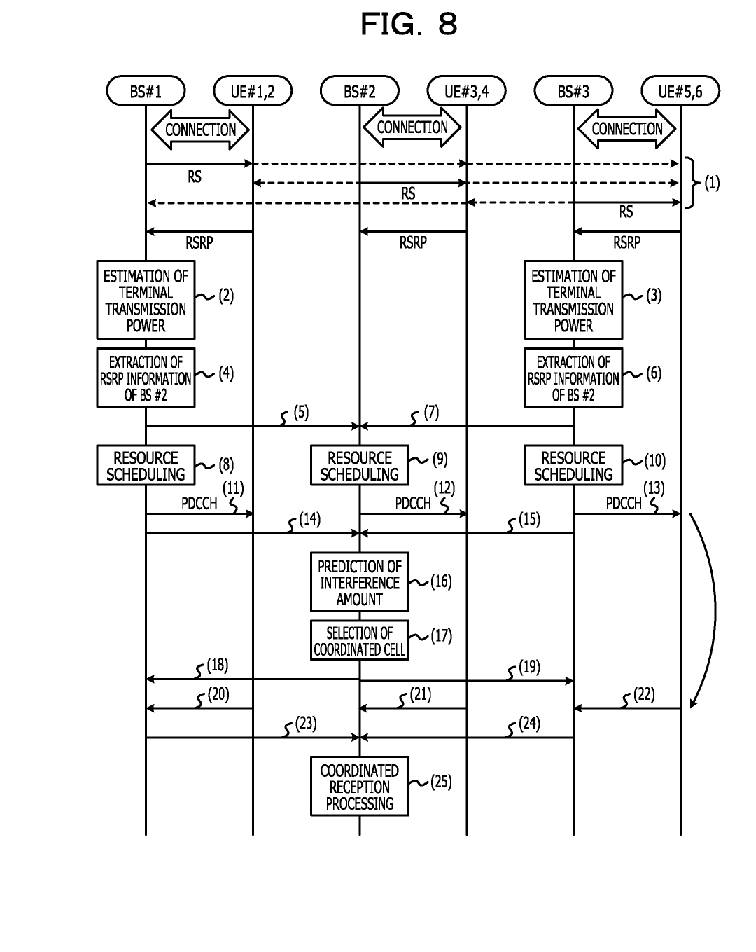

An operation example of the network system illustrated in FIG. 4 is described below. FIG. 8 is a sequence diagram illustrating the operation example in the second embodiment, and the operation example in the BS #2 is described below. The operation example illustrated in FIG. 8 is an example in which the number of adjacent cells of a certain cell (local cell: BS #2) is 2, and the number of selected coordinated cells is 1.

<<Procedure 1: (1) of FIG. 8>>

Each of the UE #1 to #6 measures a reception power value of a reference signal (RS) transmitted from each of the BS #1 to #3 (hereinafter referred to as “RSRP”). Each of the UE #1 to #6 notifies a base station (one of the BS #1 to #3) to which the UE is coupled, of RSRP information using an uplink signal.

The RSRP information includes RSRP of the local cell and an adjacent cell. For example, the RSRP information from the UE #1 and #2 includes at least the RSRP of the BS #1 and the RSRP of the BS #2. In addition, RSRP information from the UE #5 and #6 includes at least the RSRP of the BS #3 and the RSRP of the BS #2.

<<Procedure 2: (2) and (3) of FIG. 8>>

The BS #1 that is an adjacent base station of the BS #2 estimates a current transmission power value using the RSRP information of the BS #1, which has been notified (reported) from the UE #1 and #2 under the control of the BS #1. Similar to the BS #1, the BS #3 that is an adjacent base station of the BS #2 also estimates a current transmission power value using the RSRP information of the BS #3, which has been notified (reported) from the UE #5 and #6 under the control of the BS #3.

An estimation value P_{UE} of transmission power value of the UE is calculated, for example, using the following formula (4).

P_{UE}=min(P₀+α(P_{RS}−P_{RSRP}), Pₘₐₓ) (4)

Here, “P_{RS}” indicates a transmission power value [dBm] of a reference signal. “P_{RSRP}” indicates a reception power value [dBm] that has been reported from the UE. “P₀” and “α” indicate transmission power control parameters set by the base station. “Pₘₐₓ” indicates the maximum transmission power value [dBm] of the UE.

<<Procedure 3: (4), (5), (6), and (7) of FIG. 8>>

The BS #1 extracts the RSRP of the BS #2, which has been reported from the UE #1 and #2 ((4) of FIG. 8), and notifies the BS #2 of the transmission power value (estimation value) and the RSRP of the BS #2 ((5) of FIG. 8). The BS #3 extracts the RSRP of the BS #2, which has been reported from the UE #5 and #6 ((6) of FIG. 8), and notifies the BS #2 of the transmission power value (estimation value) and the RSRP of the BS #2 ((7) of FIG. 8). However, the transmission power value and the RSRP may be notified separately. The above-described operations (1) to (7) are performed periodically.

<<Procedure 4: (8), (9), and (10) of FIG. 8>>

Each of the BS #1, #2, and #3 performs scheduling of resources. That is, each of the BS #1, #2, and #3 selects UE having the largest proportional fairness (PF) coefficient, from among pieces of UE under the control of the BS, and determines a wireless resource to which an uplink signal is allocated. The PF coefficient is a coefficient used to maintain fairness between users (UE), and for example, a value represented by the following formula (5) is calculated.

$${M}_{i , j} = \frac{f ( {SIR}_{i , j} )}{{R}_{i}} \qquad ( 5 )$$

Here, “SIR_{i,j}” is an SIR value in a resource #j of a user (UE) #i (i and j are integers that indicate addresses). The SIR value is calculated using the channel quality that has been measured from an SRS transmitted from UE periodically and an average interference amount that has been measured in the BS. Here, “f” indicates a function used to calculate a transmission bit rate from the SIR value. In addition, “ᵢ” indicates an average transmission bit rate.

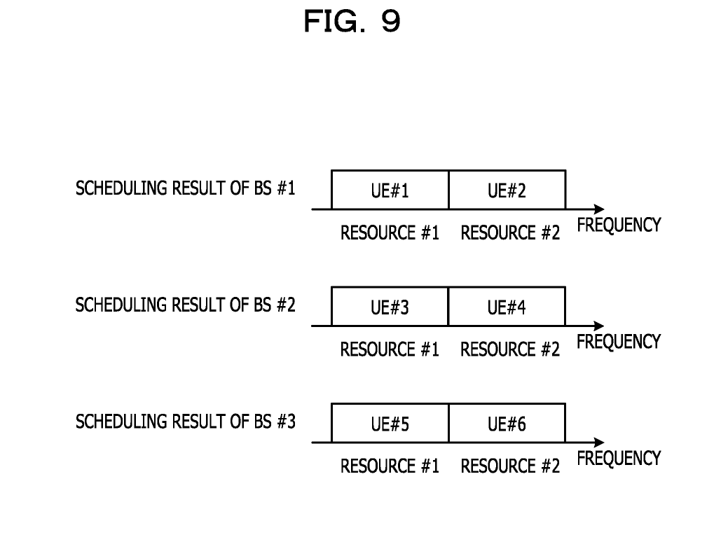

FIG. 9 is a diagram illustrating an example of scheduling results of wireless resources of uplink in the BS #1, #2, and #3. The wireless resources #1 and #2 are resources having the same frequency (resources having commonality between base stations). As illustrated in FIG. 9, the BS #1 allocates the UE #1 to the wireless resource #1, and allocates the UE #2 to the wireless resource #2. The BS #2 allocates the UE #3 to the wireless resource #1, and allocates the UE #4 to the wireless resource #2. The BS #3 allocates the UE #5 to the wireless resource #1, and allocates the UE #6 to the wireless resource #2.

<<Procedure 5: (11), (12), and (13) of FIG. 8>>

Each of the BS #1, #2, and #3 notifies UE that is a resource allocation target of a wireless resource information including the resource scheduling result that has been determined in the procedure 4 using a physical downlink control channel (PDCCH). That is, the BS #1 notifies the UE #1 and #2 of the wireless resource information ((11) of FIG. 8), and the BS #2 notifies the UE #3 and #4 of the wireless resource information ((12) of FIG. 8), and the BS #3 notifies the UE #5 and #6 of the wireless resource information ((13) of FIG. 8).

When wireless communication standard supported by each base station (BS) is Long Term Evolution (LTE), it is defined in the standard that the actual uplink transmission is performed after 4 sub-frames from reception of the wireless resource information notification by the BS. Here, the wireless communication standard supported by the BS is not limited to LTE and LTE-Advanced.

<<Procedure 6: (14) and (15) of FIG. 8>>

Each of the adjacent base stations (BS #1 and #3) notifies the BS #2 of the allocation result of the wireless resources that have been determined in the procedure 4. The notification includes information indicating UE and a resource to which the UE is allocated.

<<Procedure 7: (16) and (17) of FIG. 8>>

The BS #2 predicts an interference amount from each of the adjacent base stations in each of the wireless resources, based on the information that has been notified from the BS #1 and #3 ((16) of FIG. 8). For example, when the scheduling result corresponds to the example illustrated in FIG. 9, an interference amount I_{R#1,BS#1} [dBm] from the BS #1 (cell #1) in the wireless resource #1 is obtained, for example, using the following formula (6).

I_{R#1,BS#1}=P_{UE#1}+P_{RSRP,BS#2@UE#1}−P_{RS,BS#2} (6)

Here, “P_{UE#1}” indicates a transmission power value of the UE #1, which has been reported from the BS #1 in the procedure 2.“P_{RSRP,BS#2@UE #1}” is an RSRP value of the BS #2, which has been measured in the UE #1, and has been reported from the BS #1 in the procedure 3. “P_{RS,BS#2}” indicates a transmission power value of a reference signal of the BS #2. In the above-described formula, the transmission power value or the like of the UE #1 is used, but a transmission power value or the like of the UE #2 may be used. That is, a transmission power value having the largest interference amount is used for “comparison” described later.

The BS #2 obtains, using the formula (6), an interference amount I_{R#1,BS#3} [dBm] from the BS #3 (cell #3) in the wireless resource #1, an interference amount I_{R#2,BS#1} [dBm] from the BS #1 (cell #1) in the wireless resource #2, and an interference amount I_{R#2,BS#3} [dBm] from the BS #3 (cell #3) in the wireless resource #2.

After that, the BS #2 compares the above-calculated interference amounts with each other, and determines a base station (BS) having the largest interference amount, for each of the wireless resources (FIG. 8 (17)). For example, when the following formulas (7) and (8) are satisfied, the BS #1 is selected as a coordinated cell of the wireless resource #1, and selects the BS #3 as a coordinated cell of the wireless resource #2. In the wireless resource#1, the interference amount from the BS #1 is larger than the interference amount from the BS #3, and in the wireless resource #2, the interference amount from the BS #3 is larger than the interference amount from the BS #1.

I_{R#1,BS#1}>I_{R#1,BS#3} (7)

I_{R#2,BS#1}<I_{R#2,BS#3} (8)

In the embodiment, the candidates of the coordinated cells are two of the BS #1 and #3. When the candidates of the coordinated cells are three or more, a coordinated cell is selected in order of the size of an interference amount, largest first. When the number of coordinated cells (adjacent cells) used for coordinated reception is one, an adjacent cell having the maximum interference amount is selected as the coordinated cell. When the number of coordinated cells (adjacent cells) used for coordinated reception is a certain value of two or more, the adjacent cells the number of which is the same as the certain value are selected as coordinated cells, in order of the size of an interference amount, largest first.

“I_{R#1,BS#1}” is an example of “each of a plurality of pieces of first information relating to each amount of each interference caused to a desired signal by each interference signal”or “each of the plurality of pieces of the first information indicating each amount of each interference caused to the desired signal by each interference signal”. “P_{UE#1}” is an example of “each of a plurality of pieces of second information indicating each transmission power of each signal transmitted from each wireless terminal under control of each of the plurality of other base stations”. “P_{RSRP,BS#2@UE#1}” is an example of “each of a plurality of pieces of third information indicating each reception power of a signal transmitted from the base station, each reception power being measured in each wireless terminal under control of each of the plurality of other base stations”. “P_{RS,BS#2}” is an example of “fourth information indicating a transmission power of a signal transmitted from the base station”. Such information used to calculate an interference amount is stored in the storage device 52 as “information on interference from the further wireless terminal”, and managed by the user information management unit 116.

<<Procedure 8: (18) and (19) of FIG. 8>>

The BS #2 performs obtaining reservation of a uplink reception signal ((18) and (19) of FIG. 8), on the coordinated base stations (the BS #1 for the wireless resource #1 and the BS #3 for the wireless resource #2) that has been determined in the procedure 7 ((17 of FIG. 8).

<<Procedure 9: (20), (21), (22), (23), and (24) of FIG. 8>>

Each of the UE #1 to #6 performs transmission of an uplink signal, using a wireless resource that has been allocated at certain timing (for example, after a certain time period has elapsed from reception of a PDCCH) ((20), (21), and (22) of FIG. 8).

The BS #1 transmits a reception signal in the wireless resource #1 to the BS #2 through the base station-to-base station IF 119, in response to the obtaining reservation (reservation request) from the BS #2 ((23) of FIG. 8). In addition, the BS #3 transmits a reception signal in the wireless resource #2 to the BS #2 through the base station-to-base station IF 119, in response to obtaining reservation (reservation request) from the BS #2 ((24) of FIG. 8).

<<Procedure 10: (25) of FIG. 8 >>

The BS #2 executes coordinated reception processing (weight calculation, equalization processing, IDFT, and decoding) using the reception signal from the local cell (cell #2) and the signals that have been obtained from the BS #1 and #3 in the procedure 9 to obtain pieces of desired data from the UE #3 and UE #4.

<Effect of the Second Embodiment>

In the second embodiment, similar to the first embodiment, adjacent base stations the number of which is the same as the certain number of selected coordinated base stations are selected as coordinated base stations, in order of the size of an interference amount, largest first, from among a plurality of adjacent base stations that are candidates of coordinated base stations. Therefore, the quality of the reception signal may be improved while the influence of the interference residual amount is suppressed, and the characteristics of the coordinated reception (throughputs of uplink transmission) may be improved.

In addition, in the second embodiment, there is the following advantage. Typically, as the number of coordinated cells (the number of coordinated base stations) is increased, the characteristics of the coordinated reception are improved. However, as the number of coordinated cells is increased, the load of the base station-to-base station IF is also increased. In addition, even in a configuration in which baseband units (BBU) are collectively provided, and a plurality of remote radio heads (RRH) is provided, a transfer amount between the cells is increased.

In a case in which the number of reception antennas is set at two and the bandwidth is set at 10 [MHz] when a reception signal for each sub-frame is obtained, transfer speed of about 300 Mbps per one cell is desired. The desired transfer speed is increased depending on the number of coordinated cells. In addition, when the local cell obtains reception signals from a plurality of cells in parallel, the transfer amount is increased. In addition, in the base station that receives a reception signal from the adjacent cell, inverse matrix calculation for a channel matrix that depends on the number of coordinated cells is performed. The number of elements of the channel matrix is increased as the number of coordinated cells is increased, so that a processing amount of the base station is increased. As described above, in view from a reduction in the load of the base station, it is desirable that the characteristics are improved by the smaller number of coordinated cells. In the second embodiment, the characteristics (throughputs) of the coordinated reception may be improved without increasing the number of coordinated cells.

<Modification>

In the operation example illustrated in FIG. 8, in the procedure 7 ((16) and (17) of FIG. 8), the interference amount from the adjacent cell is calculated, the adjacent cell having the large interference amount is selected as the coordinated cell. On the contrary, an SIR when coordinated reception has been performed is estimated, and an adjacent cell (adjacent base station) having the largest expected SIR may be selected as the coordinated cell.

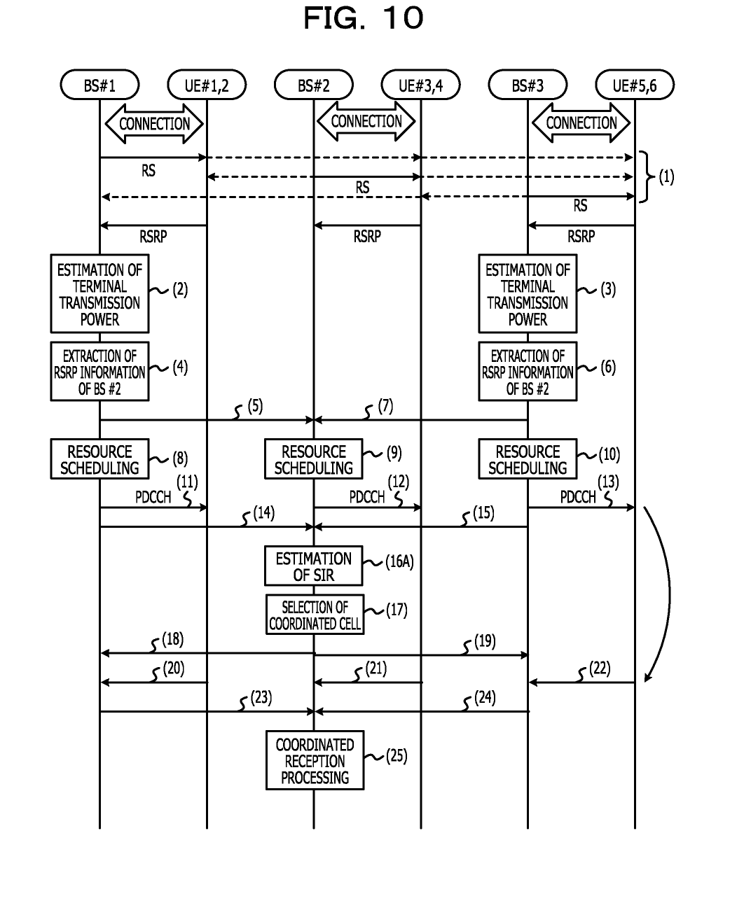

FIG. 10 is a sequence diagram illustrating a modification. The sequence of FIG. 10 is different from the sequence of FIG. 8 in that processing (16A) is provided instead of the processing (16) in FIG. 8. Pieces of processing other than the processing (16A) are similar to those of FIG. 8, so that the description is omitted herein.

In the processing (16A) of FIG. 10, the following processing is executed. The BS #2 calculates a prediction value of an SIR value (expected SIR) SIR_{R#1,BS#1} of the BS #1 in the wireless resource #1, for example, using the following formula (9).

$${SIR}_{R \#1 , BS \#1} = \frac{\begin{matrix}10 \frac{{P}_{UE \#3} + {P}_{RSRP , BS \#2 @ UE \#3} - {P}_{RS , BS \#2}}{10} + \\ 10 \frac{{P}_{UE \#3} + {P}_{RSRP , BS \#1 @ UE \#3} - {P}_{RS , BS \#1}}{10}\end{matrix}}{10 \frac{{I}_{average , BS \#2}}{10} - 10 \frac{{I}_{R \#1 , BS \#1}}{10}} \qquad ( 9 )$$

Here, “P_{UE#3}” indicates a transmission power value [dBm] of the UE#3, which has been calculated in the BS#2. “P_{RSRP,BS#2@UE#3}” indicates a RSRP value [dBm] of the BS #2, which has been measured in the UE#3, and has been grasped by the BS #2. “P_{RSRP,BS#1@UE#3}” indicates a RSRP value [dBm] of the BS #1 in the UE#3, which has been obtained from the BS #1. “I_{average,BS#2}” indicates an average interference power value [dBm], which has been measured in the BS #2.

“P_{UE#3}” is an example of “information indicating the transmission power of a terminal under the control of the base station, which has been obtained in the base station”. “P_{RSRP,BS#2@UE#3}” is an example of “information indicating the reception power from the base station, which has been obtained in the terminal under the control of the base station”. “P_{RSRP,BS#1@UE#3}” is an example of “information indicating reception power from the adjacent base station, which has been obtained in the terminal under the control of the base station”. “I_{average,BS#2}” is an example of “interference power value that has been obtained in the base station”. The information used to calculate an estimation value of an SIR, which includes such pieces of information, is stored in the storage device 52 as “information on the qualities of signals that a plurality of adjacent base stations receives from wireless terminals under the control of the base stations”, and is managed by the user information management unit 116.

The BS #2 obtains a prediction value SIR_{R#1,BS#3}, a prediction value SIR_{R#2,BS#1}, and a prediction value SIR_{R#2,BS#3,} using the formula (9). In addition, the BS #2 compares the prediction value SIR_{R#1,BS#1} with the prediction value SIR_{R#1,BS#3}, and determines an adjacent base station having the largest SIR value (that is, the largest interference amount), as a coordinated base station related on the wireless resource #1 (FIG. 10 (17)). In addition, the BS #2 compares the prediction value SIR_{R#2,BS#1} with the prediction value SIR_{R#2,BS#3}, and determines an adjacent base station having the largest SIR value (that is, the largest interference amount), as a coordinated base station related to the wireless resource #2 (FIG. 10 (17)). The prediction value (expected value) of the SIR is an example of “each of a plurality of pieces of first information relating to each amount of each interference caused to a desired signal by each interference signal” or “each of the plurality of pieces of the first information indicates each channel quality based on the desired signal and each interference signal” or “each of the plurality of pieces of the first information indicates each signal to interference ratio (SIR) based on the desired signal and each interference signal”.

In the modification, an operation effect similar to those of the first and second embodiments may be obtained. The configurations of the above-described embodiments may be combined as appropriate.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station comprising:
a processor configured to perform coordinated reception of a signal transmitted from a specified wireless terminal under control of the base station, with at least one coordinated base station;
a memory configured to store each of a plurality of pieces of first information relating to each amount of each interference caused to a desired signal by each interference signal, the desired signal being transmitted from the specified wireless terminal, each interference signal being transmitted from each wireless terminal under control of each of a plurality of other base stations; and
the processor configured to select the at least one coordinated base station from among the plurality of other base stations based on the plurality of pieces of the first information.

2. The base station according to claim 1, wherein
each of the plurality of pieces of the first information indicates each amount of each interference caused to the desired signal by each interference signal, and
the processor is configured to preferentially select at least one of the plurality of other base stations that corresponds to a larger amount of interference indicated by a corresponding piece of the first information, to be the at least one coordinated base station.

3. The base station according to claim 1, wherein
each of the plurality of pieces of the first information indicates each channel quality based on the desired signal and each interference signal, and
the processor is configured to preferentially select at least one of the plurality of other base stations that corresponds to a better channel quality indicated by a corresponding piece of the first information, to be the at least one coordinated base station.

4. The base station according to claim 1, wherein
each of the plurality of pieces of the first information indicates each signal to interference ratio (SIR) based on the desired signal and each interference signal, and
the processor is configured to preferentially select at least one of the plurality of other base stations that corresponds to a better SIR indicated by a corresponding piece of the first information, to be the at least one coordinated base station.

5. The base station according to claim 1, wherein
the processor is configured to select the predetermined number of the at least one coordinated base station.

6. The base station according to claim 1, wherein
the processor is configured to:
receive each of a plurality of pieces of second information and each of a plurality of pieces of third information from each of the plurality of other base stations, each of a plurality of pieces of the second information indicating each transmission power of each signal transmitted from each wireless terminal under control of each of the plurality of other base stations, each of a plurality of pieces of the third information indicating each reception power of a signal transmitted from the base station, each reception power being measured in each wireless terminal under control of each of the plurality of other base stations, and
calculate the first information based on the second information and the third information.

7. The base station according to claim 6, wherein
the processor is configured to calculate the first information further based on fourth information indicating a transmission power of a signal transmitted from the base station.

8. A control method performed by a base station, the control method comprising:
performing coordinated reception of a signal transmitted from a specified wireless terminal under control of the base station, with at least one coordinated base station;
storing each of a plurality of pieces of first information relating to each amount of each interference caused to a desired signal by each interference signal, the desired signal being transmitted from the specified wireless terminal, each interference signal being transmitted from each wireless terminal under control of each of a plurality of other base stations; and
selecting the at least one coordinated base station from among the plurality of other base stations based on the plurality of pieces of the first information.

9. The control method according to claim 8, wherein
each of the plurality of pieces of the first information indicates each amount of each interference caused to the desired signal by each interference signal, and
the base station is configured to preferentially selects at least one of the plurality of other base stations that corresponds to a larger amount of interference indicated by a corresponding piece of the first information, to be the at least one coordinated base station.

10. The control method according to claim 8, wherein
each of the plurality of pieces of the first information indicates each channel quality based on the desired signal and each interference signal, and
the base station is configured to preferentially select at least one of the plurality of other base stations that corresponds to a better channel quality indicated by a corresponding piece of the first information, to be the at least one coordinated base station.

11. The control method according to claim 8, wherein
each of the plurality of pieces of the first information indicates each signal to interference ratio (SIR) based on the desired signal and each interference signal, and
the base station is configured to preferentially select at least one of the plurality of other base stations that corresponds to a better SIR indicated by a corresponding piece of the first information, to be the at least one coordinated base station.

12. The control method according to claim 8, wherein
the base station is configured to select the predetermined number of the at least one coordinated base station.

13. The control method according to claim 8, wherein
the base station is configured to:
receive each of a plurality of pieces of second information and each of a plurality of pieces of third information from each of the plurality of other base stations, each of a plurality of pieces of the second information indicating each transmission power of each signal transmitted from each wireless terminal under control of each of the plurality of other base stations, each of a plurality of pieces of the third information indicating each reception power of a signal transmitted from the base station, each reception power being measured in each wireless terminal under control of each of the plurality of other base stations, and
calculate the first information based on the second information and the third information.

14. The control method according to claim 13, wherein
the base station is configured to calculate the first information further based on fourth information indicating a transmission power of a signal transmitted from the base station.
